(19) United States
(12) Patent Application Publication
(10) Pub. No.: US 2009/0028034 A1
(43) Pub. Date: Jan. 29, 2009

(54) TEMPERATURE CONTROL APPARATUS FOR OPTICAL CRYSTAL

(75) Inventor: Toshiki Onishi, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 12/177,583

(22) Filed: Jul. 22, 2008

(30) Foreign Application Priority Data
Jul. 25, 2007 (JP) 2007-192803
Apr. 18, 2008 (JP) 2008-109297

(51) Int. Cl. G11B 7/00

(52) U.S. Cl. 369/112.02

(57) ABSTRACT

A temperature control apparatus for optical crystal can employ a general temperature control element as is, can be controlled by a single temperature sensor and is applicable to patterns that produce complex temperature distributions. This temperature control apparatus has an optical crystal (100) that allows a beam to transmit inside the optical crystal, a temperature control element (not shown) that generates or absorbs heat and a heat conducting element (101) that is arranged between the temperature control element and the optical crystal (100) and that conducts heat between the temperature control element and the optical crystal (100), and the heat conducting element (101) conducts different amounts of heat depending on locations in the heat conducting element to reduce the temperature variation in the optical crystal (100).

### CROSS REFERENCE TO RELATED APPLICATIONS

The disclosures of Japanese Patent Application No. 2007-192803, filed on Jul. 25, 2007, and Japanese Patent Application No. 2008-109297, filed on Apr. 18, 2008, including the specifications, drawings and abstracts, are incorporated herein by reference in their entirety.

### BACKGROUND OF THE INVENTION

1. Field of the Invention

The present invention relates to a temperature control apparatus for optical crystal.

2. Description of the Related Art

Conventional temperature control apparatuses for optical crystal include, for example, the one with a plurality of temperature sensors and temperature control elements, disclosed in Japanese Patent Application Laid-Open No. 2004-53781.

FIG. 1 shows the conventional temperature control apparatus disclosed in the above publication. In FIG. 1, the second harmonic generation apparatus, which is a temperature control apparatus, has cover 1000, base plate 1001, thermoelectric cooling elements 1002, 1003 and 1004, SHG element 1005, optical waveguide 1005a, SHG element support 1006, and groove 1006a and micro-grooves 1006b. SHG element 1005 generates the second harmonic of an incident laser light. Thermoelectric cooling elements 1002, 1003 and 1004 adjust the temperature of SHG element 1005. Thermoelectric cooling elements 1002, 1003 and 1004 are configured to change the extent of heating up and cooling down, in both ends and the middle of SHG element 1005 in the direction of propagation of the light. By this means, even if the optical path length of the SHG element is not so long, the temperature control apparatus disclosed in the above publication is able to make the temperature distribution in the direction of propagation of the light uniform at a temperature as much as possible such that high efficiency of conversion to the second harmonic can be maintained.

Conventional temperature control apparatuses include the one using heating elements that produce different calorific values depending on locations in the optical element, disclosed in, for example, Japanese Patent Application Laid-Open No. HEI11-125800.

FIG. 2 shows the conventional temperature control apparatus disclosed in the above publication. In FIG. 2, the temperature control apparatus has electrical wires 1100, optical element 1101, line contact heaters 1102a and 1102b, Peltier elements 1103a and 1103b, laser light inlet section 1004 and heater power supply 1105. Optical element 1101 controls a laser light. Line contact heaters 1102a and 1102b are provided on faces of the optical element where the laser light does not pass, as a means for linear heating in a direction parallel to the optical axis of the laser light. The line width of these heating means is less than the beam diameter of the laser light. Further, this temperature control apparatus provides cooling means on faces of the optical element where the laser light does not pass and where the heating means are not provided. Further, this temperature control apparatus employs a configuration of utilizing wedge-shaped heaters or thermoelectric wires in close contact with optical elements as heating means for the optical crystal and decreasing the calorific value per unit length near the laser light output face compared to near the laser light input face of the optical element.

However, the technique of using a plurality of temperature sensors and temperature control elements, disclosed in Japanese Patent Application Laid-Open No. 2004-53781, has the following problems. First, this technique requires a plurality of temperature sensors and temperature control elements and so is complex. Further, each pair of a temperature sensor and a temperature control element requires an individual temperature controlling circuit, which results in greater power consumption, greater apparatus scale and greater cost. In addition, with patterns other than a pattern where the laser light linearly passes through the optical crystal only once, temperature distribution is complex, and so it is difficult to carry out temperature control supporting the complex temperature distribution. Furthermore, due to the physical limit of the width of the temperature control element, a plurality of temperature control elements cannot be aligned depending on the length of the optical crystal.

On the other hand, the technique of changing the calorific value depending on locations in the optical element, disclosed in Japanese Patent Application Laid-Open No. HEI11-125800, has the following problems. First, if the line width of the heating element is made shorter than the beam diameter of a laser light and then the heating element needs to be arranged in parallel with the laser light, adjusting the position of the heating element is very difficult. In addition, with patterns other than a pattern where the laser light linearly passes only once through the optical crystal, temperature distribution is complex, and so it is difficult to carry out temperature control supporting the complex temperature distribution. Further, a general heating means cannot be used, and so different heating means needs to be made on a per optical crystal basis.

### SUMMARY OF THE INVENTION

It is therefore an object of the present invention to provide a temperature control apparatus for optical crystal, that can employ a general temperature control element (means) as is, that can be controlled by a single temperature sensor and that is applicable to patterns that produce complex temperature distributions.

According to the present invention, the temperature control apparatus for optical crystal has an optical crystal that allows a beam to transmit inside the optical crystal; a temperature control element that generates or absorbs heat; and a heat conducting element that is arranged between the temperature control element and the optical crystal and conducts heat between the temperature control element and the optical crystal, and the heat conducting element conducts different amounts of heat depending on locations in the heat conducting element to reduce a temperature variation in the optical crystal and thereby achieve the above object.

As described above, the temperature control apparatus according to the present invention is able to realize a temperature control apparatus for optical crystal, that can employ a general temperature control element (means) as is, that can be controlled by a single temperature sensor and that is applicable to patterns that produce complex temperature distributions.

### BRIEF DESCRIPTION OF THE DRAWINGS

FIG. 1 is a schematic view of a conventional temperature control apparatus;

FIG. 2 is a schematic view of the conventional temperature control apparatus;

FIG. 3 is a transparent view of a temperature control apparatus according to Embodiment 1 of the present invention;

FIG. 4 is a transparent view of the temperature control apparatus according to Embodiment 1;

FIG. 5 is a perspective view of the temperature control apparatus according to Embodiment 1;

FIG. 6 is a perspective view of a heat conducting element according to Embodiment 1;

FIG. 7 is a perspective view of the heat conducting element according to Embodiment 1;

FIG. 8 is a perspective view of the heat conducting element according to Embodiment 1;

FIG. 9 is a transparent view of the temperature control apparatus according to Embodiment 2 of the present invention;

FIG. 10 is a transparent view of the temperature control apparatus according to Embodiment 2;

FIG. 11 is a perspective view of the temperature control apparatus according to Embodiment 2;

FIG. 12 is a transparent view of the temperature control apparatus according to Embodiment 3 of the present invention;

FIG. 13 is a transparent view of the temperature control apparatus according to Embodiment 3;

FIG. 14 is a perspective view of the temperature control apparatus according to Embodiment 3;

FIG. 15 is a transparent view of the temperature control apparatus according to Embodiment 4 of the present invention;

FIG. 16 is a transparent view of the temperature control apparatus according to Embodiment 4;

FIG. 17 is a perspective view of the temperature control apparatus according to Embodiment 4;

FIG. 18 is a perspective view of the heat conducting element according to Embodiment 4;

FIG. 19 is a perspective view of the heat conducting element according to Embodiment 4;

FIG. 20 is a perspective view of the heat conducting element according to Embodiment 4;

FIG. 21 is a perspective view of the heat conducting element according to Embodiment 4;

FIG. 22 is a transparent view of the temperature control apparatus according to Embodiment 5 of the present invention;

FIG. 23 is a transparent view of the temperature control apparatus according to Embodiment 5;

FIG. 24 is a perspective view of the temperature control apparatus according to Embodiment 5;

FIG. 25 is a transparent view of the temperature control apparatus according to Embodiment 6 of the present invention;

FIG. 26 is a transparent view of the temperature control apparatus according to Embodiment 6;

FIG. 27 is a perspective view of the temperature control apparatus according to Embodiment 6;

FIG. 28 is a perspective view of the temperature control apparatus according to Embodiment 7 of the present invention;

FIG. 29 is a schematic view of a known reflective reciprocating wavelength conversion apparatus;

FIG. 30 is a transparent view of the temperature control apparatus according to Embodiment 8 of the present invention; and

FIG. 31 is a transparent view of the temperature control apparatus according to Embodiment 8.

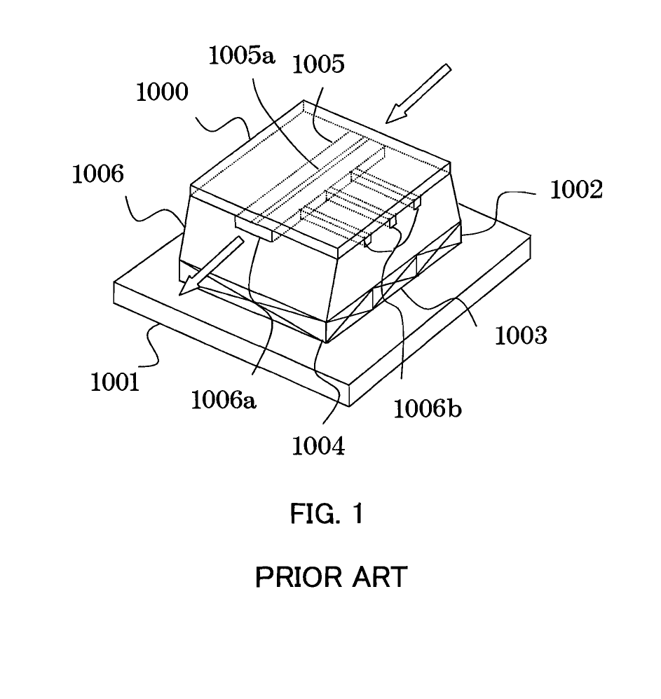

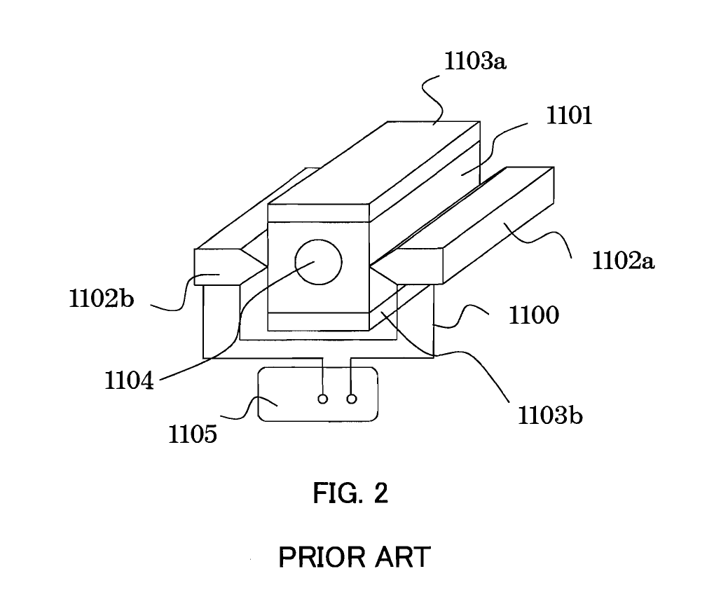

### DETAILED DESCRIPTION OF THE PREFERRED EMBODIMENT

Embodiments of the present invention will be described in detail below with reference to the accompanying drawings.

### Embodiment 1

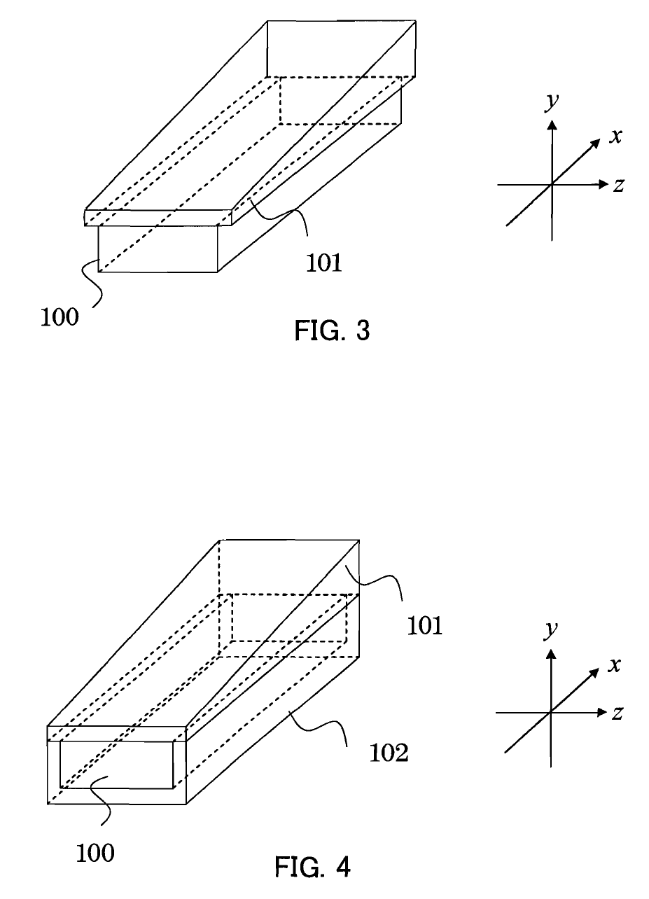

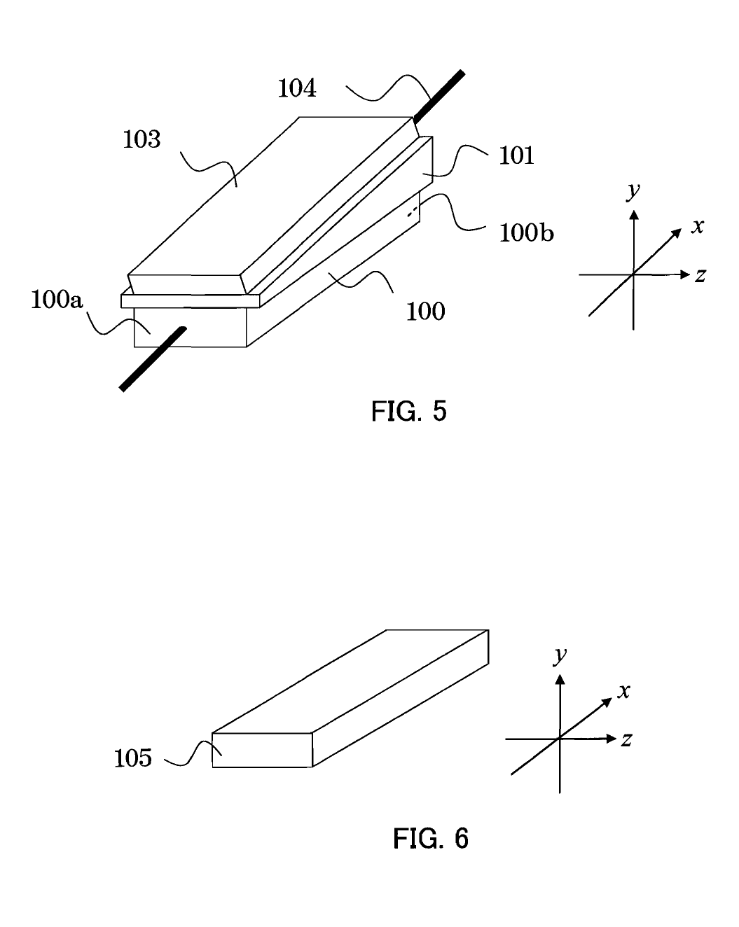

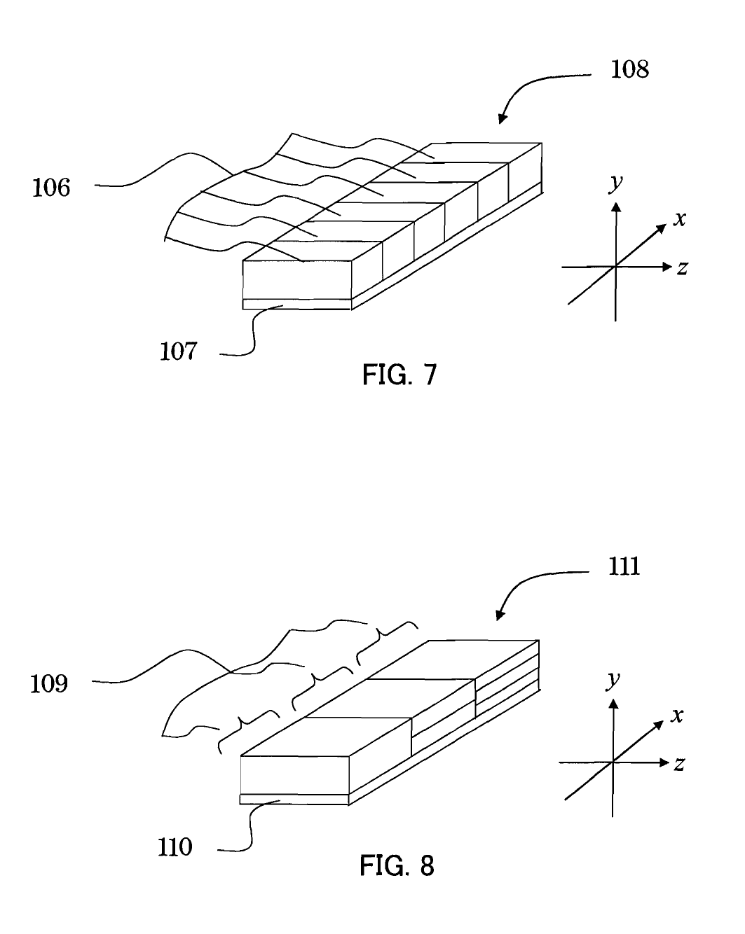

FIG. 3 and FIG. 4 are transparent views of a temperature control apparatus according to Embodiment 1 of the present invention. FIG. 5 is a perspective view of the temperature control apparatus according to Embodiment 1 of the present invention. Further, FIG. 6, FIG. 7 and FIG. 8 are perspective views of a heat conducting element used in the temperature control apparatus according to Embodiment 1 of the present invention.

Further, in each drawing described in the following embodiments, the traveling direction of a laser light inside the optical crystal will be referred to as “x-axis direction,” the direction which is parallel to the face of optical crystal where the temperature control apparatus is arranged and which is orthogonal to the x-axis direction, will be referred to as “z-axis direction,” and the direction which is orthogonal to the x-axis direction and the z-axis direction will be referred to as “y-axis direction.” Further, where necessary, the direction opposite to the x-axis direction, that is, the laser light input end, will be referred to as “front,” and the x-axis direction, that is, the laser light output end, will be referred to as “back.” Further, where necessary, using the optical path of the laser light as a reference, the right direction in the drawings will be referred to as “right,” and the left direction in the drawings will be referred to as “left.” Furthermore, where necessary, illustration of the temperature control element and the temperature sensor will be omitted.

FIG. 3 shows the temperature control apparatus that has wedge-shaped heat conducting element 101 (form A) made entirely of the same substance and optical crystal 100 with the wavelength conversion function. Here, heat conducting element 101 (form A) has different cross sections cut in the y-z plane depending on locations. To be more specific, heat conducting element 101 (form A) becomes thicker from the front toward the back. For this reason, the thermal resistance of heat conducting element 101 (form A) in the y-axis direction (hereinafter simply “thermal resistance”) becomes greater from the front toward the back.

FIG. 4 shows the temperature control apparatus in FIG. 3 with cover 102 (form A) made of a heat conductive substance.

FIG. 5 shows a configuration of the temperature control apparatus in FIG. 3 with temperature control element 103. The temperature control apparatus in FIG. 5 employs a configuration that allows laser light 104 to transmit in optical crystal 100.

First, a case will be described where the temperature of optical crystal 100 is kept higher than the external temperature. In this case, laser light 104 is allowed to transmit from optical crystal end surface 100a toward optical crystal end surface 100b, and a heating means such as a heater or Peltier element is used for temperature control element 103. Optical crystal 100 will be described below as a harmonic generation element such as a second harmonic generation element. When laser light 104 is incident from optical crystal end surface 100a, part of laser light 104 is converted into a harmonic while it passes through optical crystal 100. Then, the light obtained by synthesizing the light of the same wavelength as the incident light and the harmonic of the incident light, is outputted as the output light. The incident light is converted into a harmonic while it passes through optical crystal 100, and so the quantity of harmonic components increases at the end of optical crystal end surface 100b than at the end of optical crystal end surface 100a.

Generally, optical crystal exhibits better light absorption characteristics with harmonics and has a feature of producing heat by absorbing light. Therefore, in optical crystal 100, temperature distribution (gradient) is produced where the temperature changes from low to high from optical crystal end surface 100a toward optical crystal end surface 100b. The efficiency of conversion for the optical crystal with the wavelength conversion function is maximum when this optical crystal is a certain temperature. For this reason, to enable efficient wavelength conversion, it is necessary to reduce unevenness in temperature distribution in optical crystal 100 and keep the temperature of the crystal at a certain temperature.

In FIG. 5, closer to optical crystal end surface 100a where heat conducting element 101 (form A) is thinner, more heat from the heating means is conducted. That is, closer to optical crystal end surface 100a, a greater amount of heat is conducted, because the thermal resistance of heat conducting element 101 (form A) decreases in proportion to the decrease in the thickness of heat conducting element 101 (form A). As described above, closer to optical crystal end surface 100a, less heat is generated by light absorption.

On the other hand, closer to optical crystal end surface 100b where heat conducting element 101 (form A) is thicker, less heat from the heating means is conducted. That is, closer to optical crystal end surface 100b, a smaller amount of heat is conducted, because the thermal resistance of heat conducting element 101 (form A) increases in proportion to the increase in the thickness of heat conducting element 101 (form A). As described above, closer to optical crystal end surface 100b, more heat is generated by light absorption.

As a result, the unevenness in temperature distribution due to wavelength conversion and the unevenness in temperature distribution due to the thermal resistance distribution of heat conducting element 101 (form A) cancel each other, so that it is possible to cancel unevenness in temperature distribution that is produced in optical crystal 100.

Next, a case will be described where the temperature of optical crystal 100 is kept lower than the external temperature. In this case, laser light 104 is allowed to transmit from optical crystal end surface 100b toward optical crystal end surface 100a, and a cooling means such as a Peltier element is used for temperature control element 103. By so doing, at the end of optical crystal end surface 100b where the crystal generates less heat by absorbing light, less heat is absorbed because the thermal resistance of the heat conducting element is greater. By contrast with this, at the end of optical crystal end surface 100a where the crystal generates more heat by absorbing light, more heat is absorbed because the thermal resistance of the heat conducting element is less in the y-axis direction. As a result, it is possible to cancel unevenness in temperature distribution throughout optical crystal 100.

Further, compared to the temperature control apparatus in FIG. 5, the temperature control apparatus with cover 102 (form A) in FIG. 4 requires the trouble of preparing a cover, but more successfully makes the temperature throughout optical crystal 100 uniform.

Further, instead of wedge-shaped heat conducting element 101 (form A), the heat conducting elements shown in FIG. 6, FIG. 7 and FIG. 8 may be used.

Heat conducting element 105 (form B) in FIG. 6 is configured with two substances of different thermal resistances (each substance consists of at least one element). Heat conducting element 105 (form B) is configured such that the concentrations of these substances vary depending on locations in heat conducting element 105 (form B), distribution is formed where thermal resistance varies depending on locations in heat conducting element 105 (form B). By this means, the unevenness in temperature distribution in optical crystal 100 that is produced when laser light 104 transmits in optical crystal 100, is cancelled. Further, changing the density of one substance naturally results in changing the proportion of the substance and a different substance, that is, the air, thereby changing the concentrations of two substances.

A case will be described for a specific example where, to keep the temperature of optical crystal 100 higher than the external temperature, heat conducting element 101 (form A) is replaced with heat conducting element 105 (form B). At this time, a laser light is incident on optical crystal 100 such that the laser light travels from optical crystal end surface 100a toward optical crystal end surface 100b. In this case, the calorific value of optical crystal 100 resulting from light absorption becomes greater toward optical crystal end surface 100b. Consequently, the heat conducting element (form B) may be configured to increase the concentration of the substance of the greater thermal resistance from optical crystal end surface 100a toward optical crystal end surface 100b.

Further, heat conducting element 105 (form B) may consist of two or more substances.

Heat conducting element 108 (form C) in FIG. 7 is formed with at least two constituent elements 106 aligned in the x-axis direction on base 107 where the thermal resistance is uniform. Here, constituent elements 106 consist of substances of different thermal resistances. Further, constituent elements 106 are aligned such that the thermal resistance increases stepwise in the direction in which the coordinate values in the x-axis direction (hereinafter “x-axis coordinate values”) increase or decrease.

In heat conducting element 108 (form C), changes in thermal resistance are not continuous, and so the performance of canceling unevenness in temperature distribution in the optical crystal is not as good as with heat conducting element 105 (form B) in FIG. 6. However, heat conducting element 108 (form C) is more useful than heat conducting element 105 (form B) because heat conducting element 108 (form C) causes less manufacturing variations and is easier to make. Further, the joining face of heat conducting element 108 (form C) with the optical crystal is on the constituent element 106 side, and the joining face of heat conducting element 108 (form C) with the temperature control element is on the base 107 side of the heat conducting element (form C).

Heat conducting element 111 (form D) in FIG. 8 is formed with at least two constituent elements 109 aligned in the x-axis direction on base 110 where the thermal resistance is uniform. In FIG. 8, as an example, heat conducting element 111 is formed with three constituent elements 109. Two of the three constituent elements are configured by overlaying a plurality of substances of different or the same thermal resistance in the y-axis direction.

Even in cases where materials made of substances of the same thermal resistance are overlaid upon one another, in reality, thermal resistance is produced between the connecting faces in the y-axis direction, because heat conductive substances such as the air, adhesive or silicon paste are sandwiched between part of or the whole of the connecting faces, that is, because there are layers (substances) of different thermal resistances. Consequently, even if the thickness in the y-axis direction is uniform, it is possible to change thermal resistance throughput the thickness for each constituent element 109 by increasing and decreasing the number of connecting faces. That is, similar to heat conducting element 108 (form C) in FIG. 7, heat conducting element 111 (form D) employs a configuration where thermal resistance varies depending on locations in heat conducting element 111 in the x-axis direction.

In this way, heat conducting element 111 (form D) in FIG. 8 differs from heat conducting element 108 (form C) in each constituent element 109 which connects several separate components.

Further, in heat conducting element 111 (form D), similar to frontmost constituent element 109 in FIG. 8, at least one constituent element 109 may be a single entity made entirely of the same substance throughout the thickness.

Here, constituent elements 109 are aligned such that the thermal resistance increases stepwise in the direction in which the x-axis coordinate value increases or in the direction in which the x-axis coordinate value decreases. In heat conducting element 111 (form D), changes in thermal resistance are not continuous compared to heat conducting element 105 (form B) in FIG. 6, and so the performance of canceling unevenness in temperature distribution in the optical crystal is not as good as with heat conducting element 105 (form B). However, heat conducting element 111 (form D) is more useful than heat conducting element 105 (form B) because heat conducting element 111 (form D) causes less manufacturing variations and is easier to make. Further, the joining face of heat conducting element 111 (form D) with the optical crystal is on the constituent element 109 side, and the joining face of heat conducting element 111 (form D) with the temperature control element is on the base 110 side of the heat conducting element (form D).

Further, heat conducting elements described so far may be used in combinations. Further, by making adjustments such that the thermal resistance varies depending on locations in the heat conducting element and nevertheless the thermal time constant is the same in all locations, there is a possibility to improve transient temperature distribution.

To be more specific, the above adjustments involve the operation of changing thermal resistance and thermal capacity between locations in the heat conducting element and making the thermal time constant, which is the product of thermal resistance and thermal capacity, a fixed value. For example, if heat conducting element 101 (form A) is configured with a single substance, the thermal resistance and the thermal capacity in the y-axis direction (hereinafter simply “thermal capacity”) increase in proportion to the thickness of heat conducting element 101. Consequently, the thermal time constant increases in proportion to the thickness. However, by making, for example, heat conducting element 105 (form B) by combining a substance of a certain thermal resistance and a certain specific heat with a substance of the same thermal resistance as the former substance and a different specific heat (or with the same specific heat and a different specific gravity), it is possible to change thermal resistance and thermal capacity depending on locations in heat conducting element 105. With the technique, heat conducting element 101 (from A) can be configured such that the thermal resistance varies depending on locations and nevertheless the thermal time constant is fixed. This technique is applicable to the heat conducting elements described below.

In all of these cases, the temperature sensor may be arranged to measure the temperature of one given point in optical crystal 100. For example, a hole may be opened in the heat conducting element and a temperature sensor may be embedded in this hole. Then, the temperature control element controls the generation or absorption of heat to keep the temperature of the given point at a desired temperature, so that the temperature in other parts of optical crystal 100 is controlled to be kept at a desired temperature by means of the shape of the heat conducting element.

Further, the joining faces of the heat conducting element with the optical crystal and with the temperature control element may be switched.

In addition, given that the joining face of the heat conducting element with the temperature control element is flat and the joining faces of general heating and/or cooling means are usually linear or flat, the general heating and/or cooling means can easily be appropriated as the temperature control elements.

### Embodiment 2

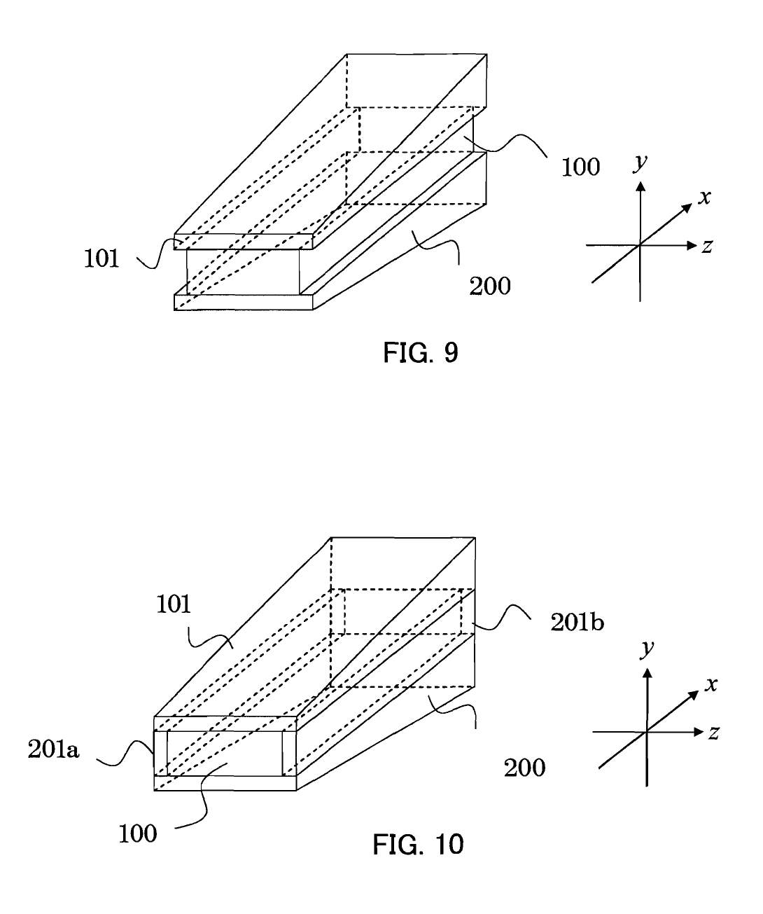

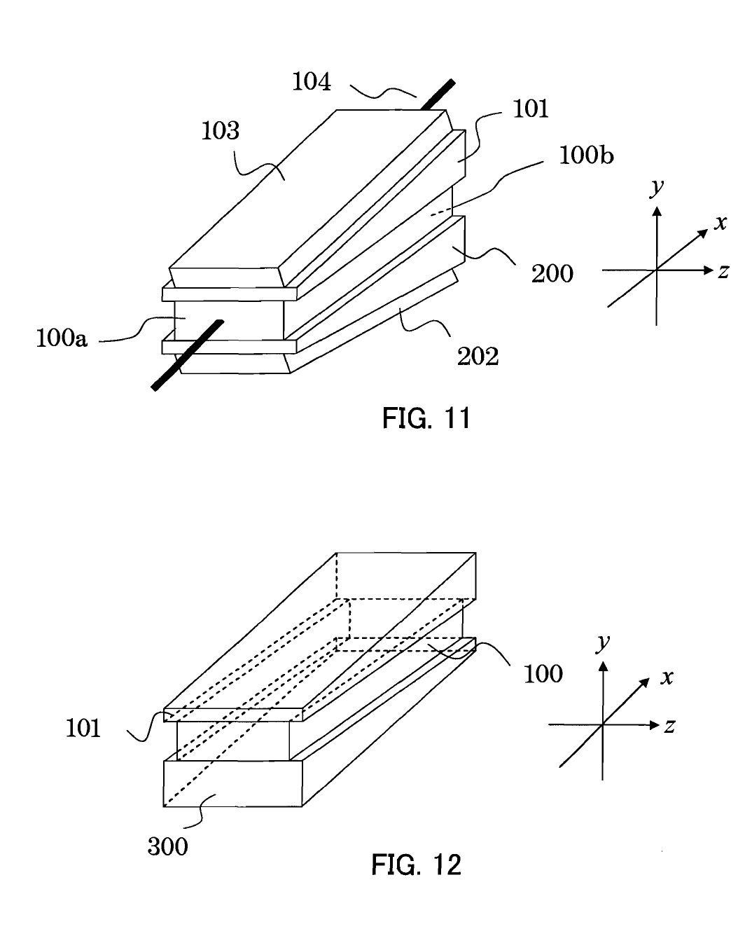

FIG. 9 and FIG. 10 are transparent views of the temperature control apparatus according to Embodiment 2 of the present invention. FIG. 11 is a perspective view of the temperature control apparatus according to Embodiment 2 of the present invention.

FIG. 9 is a transparent view of the temperature control apparatus with wedge-shaped heat conducting elements 101 (form A) and 200 made entirely of the same substance and optical crystal 100 with the wavelength conversion function. Here, heat conducting elements 101 (form A) and 200 become thicker from the front toward the back. For this reason, the thermal resistances of heat conducting elements 101 (form A) and 200 become greater from the front toward the back. Further, heat conducting elements 101 (form A) and 200 have the same shape and are arranged vertically symmetrical sandwiching optical crystal 100.

The temperature control apparatus in FIG. 10 is the temperature control apparatus in FIG. 9 with covers 201a and 201b (form B) made of a heat conductive substance.

FIG. 11 shows a configuration of the temperature control apparatus in FIG. 9 with temperature control elements 103 and 202. The temperature control apparatus in FIG. 11 employs a configuration that allows laser light 104 to transmit in optical crystal 100.

To keep the temperature of optical crystal 100 higher than the external temperature, laser light 104 is allowed to transmit from optical crystal end surface 100a toward optical crystal end surface 100b and heating means such as heaters or Peltier elements are used for temperature control elements 103 and 202.

On the other hand, to keep the temperature of optical crystal 100 lower than the external temperature, laser light 104 is allowed to transmit from optical crystal end surface 100b toward optical crystal end surface 100a, and cooling means such as Peltier elements are used for temperature control elements 103 and 202.

The principle of operation of the temperature control apparatus according to the present embodiment has the same as the principle of operation of the temperature control apparatus according to Embodiment 1. For the temperature control apparatus of Embodiment 1 shown in FIG. 5, the temperature control element joins only with one side of optical crystal 100 through heat conducting element 101 (form A). For this reason, in the temperature control apparatus in FIG. 5, uneven temperature distribution is produced in optical crystal 100 in the y-axis direction. To alleviate this unevenness, there is a form where the temperature control apparatus is attached with cover 102 (form A) as in the temperature control apparatus of Embodiment 1 shown in FIG. 4.

The temperature control apparatus according to the present embodiment increases the cost but nevertheless is able to further alleviate unevenness in temperature distribution in optical crystal 100 in the y-axis direction.

The temperature control apparatus according to the present embodiment employs a configuration where, instead of cover 102 (form A) in FIG. 4, another pair of a heat conducting element and a temperature control element are provided vertically symmetrical with respect to optical crystal 100. Here, two temperature control elements may use the same element instead of combinations of a heater and a Peltier element or combinations of Peltier elements of different characteristics. By so doing, the additional temperature control element to be added may be simply connected in serial or parallel with the existing temperature control elements connected with the temperature controlling circuit, so that an additional temperature controlling circuit needs not to be prepared.

Further, compared to the temperature control apparatus in FIG. 11, the temperature control apparatus with covers 201a and 201b (form B) in FIG. 10 requires the trouble of preparing covers, but more successfully make the temperature throughout optical crystal 100 uniform.

Furthermore, instead of wedge-shaped heat conducting elements 101 (form A) and 200, heat conducting elements shown in FIG. 6, FIG. 7 and FIG. 8 can be used.

In all of these cases, the temperature sensor needs to measure one given point of optical crystal 100. For example, a hole may be opened in the heat conducting element and a temperature sensor may be embedded in this hole. Then, by controlling the generation or absorption of heat to keep the temperature of the given point at a desired temperature, the temperature in other parts of optical crystal 100 is controlled to be kept at a desired temperature by means of the shape of the heat conducting element.

Further, the joining faces of the heat conducting element with the optical crystal and with the temperature control element may be switched.

In addition, given that the joining face of the heat conducting element with the temperature control element is flat and the joining faces of general heating and/or cooling means are usually linear or flat, the general heating and/or cooling means can easily be appropriated as the temperature control elements.

### Embodiment 3

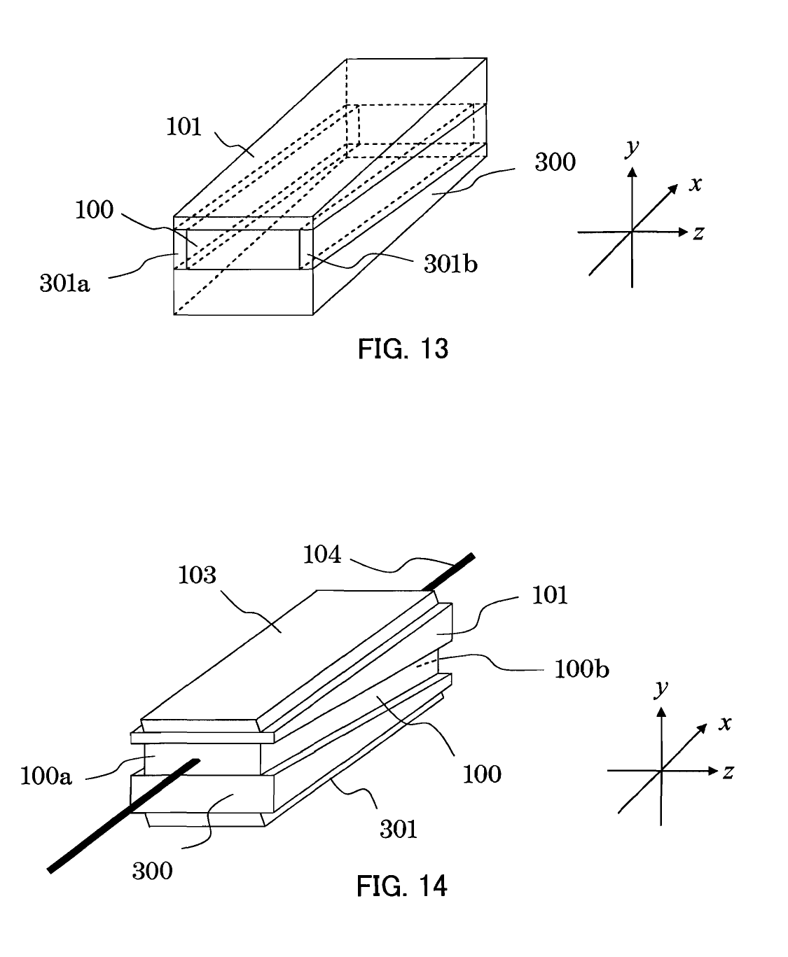

FIG. 12 and FIG. 13 are transparent views of the temperature control apparatus according to Embodiment 3 of the present invention. FIG. 14 is a perspective view of the temperature control apparatus according to Embodiment 3 of the present invention.

FIG. 12 is a transparent view of the temperature control apparatus with wedge-shaped heat conducting elements 101 (form A) and 300 made entirely of the same substance and optical crystal 100 with the wavelength conversion function. Heat conducting element 101 (form A) becomes thicker from the front toward the back. For this reason, the thermal resistance of heat conducting element 101 (form A) becomes greater from the front toward the back. Heat conducting element 300 (form A) has the same shape as heat conducting element 101 (form A), and is rotated 180 degrees around the z-axis sandwiching optical crystal 100 as shown in FIG. 12 and arranged.

The temperature control apparatus in FIG. 13 is the temperature control apparatus in FIG. 12 with covers 301a and 301b (form B) made of a heat conductive substance.

FIG. 14 shows a configuration of the temperature control apparatus in FIG. 12 with temperature control elements 103 and 301. The temperature control apparatus in FIG. 14 employs a configuration that allows laser light 104 to transmit in optical crystal 100.

With Embodiment 1 and Embodiment 2, only one of the heating means and the cooling means is used for the temperature control element. With the present embodiment, the temperature of optical crystal 100 is controlled using both the heating means and cooling means for the temperature control elements. Further, both in the case where the temperature of optical crystal 100 is kept higher than the external temperature and in the case where the temperature of optical crystal 100 is kept lower than the external temperature, the direction of incident laser light 104 (from which optical crystal end surface 100a or 100b laser light 104 is incident) is fixed and does not change.

Referring to FIG. 14, a case will be described where laser light 104 is allowed to transmit from optical crystal end surface 100a toward optical crystal end surface 100b. In this case, a heating means is used for temperature control element 103 and a cooling means is used for temperature control element 301.

It is important that the thermal resistance of heat conducting element 101 joining with the heating means increases from optical crystal end surface 100a toward optical crystal end surface 100b. Further, it is also important that the thermal resistance of heat conducting element 300 joining with the cooling means decreases from optical crystal end surface 100a toward optical crystal end surface 100b. Furthermore, it is important that the calorific value resulting from light absorption by the optical crystal increases from optical crystal end surface 100a toward optical crystal end surface 100b. By applying the above three points to the configuration of the temperature control apparatus, the unevenness in temperature distribution in optical crystal 100 is cancelled and made uniform.

Control can be carried out to use different elements such as a heater for the heating means and a Peltier element for the cooling means and operate the heating means and the cooling means at the same time. However, it is more efficient to use Peltier elements of the same characteristics for both the heating means and the cooling means and carry out the control such that only one Peltier element operates at a time.

This will be described in detail below. A temperature controlling circuit that uses general Peltier elements employs a configuration in which a control signal travels from a thermoelectric conversion circuit and, passing a controlling circuit and a current driver in order, reaches the Peltier element. Then, depending on the direction of the current traveling from the last current driver to the Peltier element, the temperature is adjusted by switching heating up and cooling down (absorption of heat) of the Peltier element by a single Peltier element.

Now, the current driver output terminal is provided with an electric circuit that utilizes, for example, a diode, and is connected in parallel with the current terminals of the Peltier elements as temperature control elements 103 and 301. Then, in the Peltier element for temperature control element 103, a current is allowed to travel only in such directions that heat conducting element 101 is heated up. On the other hand, in the Peltier element for temperature control element 301, the current is allowed to travel in such directions that heat conducting element 300 is cooled down. By this means, in the configuration of the temperature control apparatus, a current travels only in temperature control element 103 when the temperature of optical crystal 100 is increased, and a current travels only in temperature control element 301 when the temperature of optical crystal 100 is decreased.

If Peltier elements of the same characteristics are used for both the heating means and the cooling means, as a result, two Peltier elements are required but the following advantages can be obtained. The temperature controlling circuit that uses the general Peltier elements and that maintains power consumption because a current always travels only in one Peltier element, can be appropriated. Further, the Peltier element for cooling down and the Peltier element for heating up can be separated in space.

Further, compared to the temperature control apparatus in FIG. 14, the temperature control apparatus with covers 301a and 301b (form B) in FIG. 13 requires the trouble of preparing the covers, but more successfully makes the temperature throughout optical crystal 100 uniform.

Further, instead of wedge-shaped heat conducting elements 101 (form A) and 300, the heat conducting elements shown in FIG. 6, FIG. 7 and FIG. 8 can be used.

In all of these cases, the temperature sensor may be arranged to measure the temperature of one given point in optical crystal 100. For example, a hole may be opened in the heat conducting element and a temperature sensor may be embedded in this hole. Then, by controlling the generation or absorption of heat to keep the temperature of the given point at a desired temperature, the temperature in other parts of optical crystal 100 is controlled to be kept at a desired temperature by means of the shape of the heat conducting element. Further, the joining faces of the heat conducting element with the optical crystal and with the temperature control element may be switched.

In addition, given that the joining face of the heat conducting element with the temperature control element is flat and the joining faces of general heating and/or cooling means are usually linear or flat, the general heating and/or cooling means can easily be appropriated as the temperature control elements.

### Embodiment 4

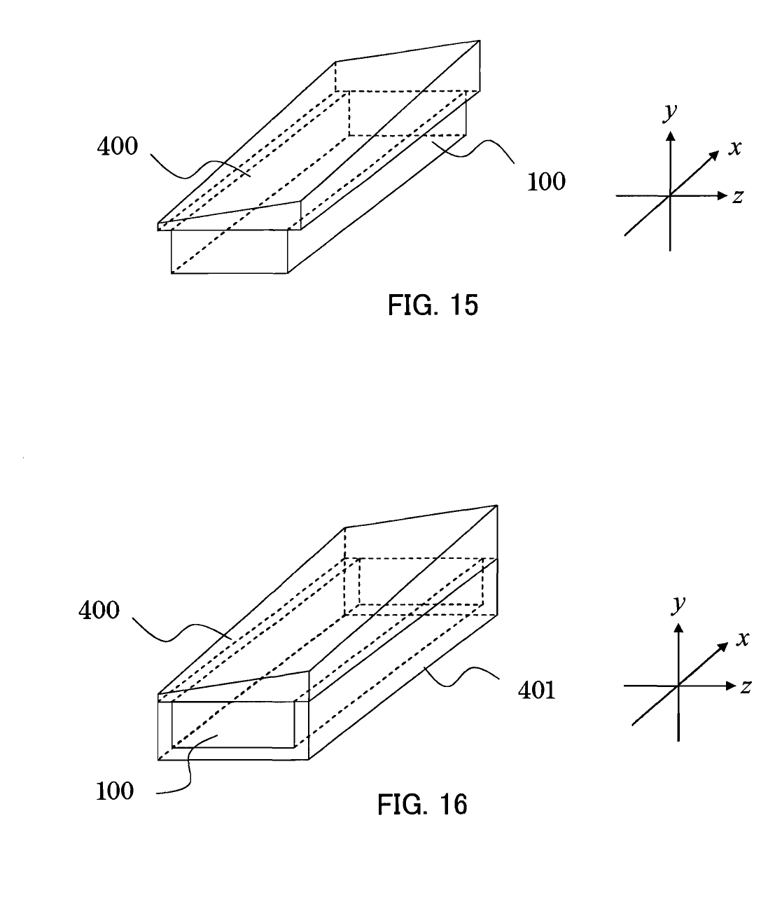

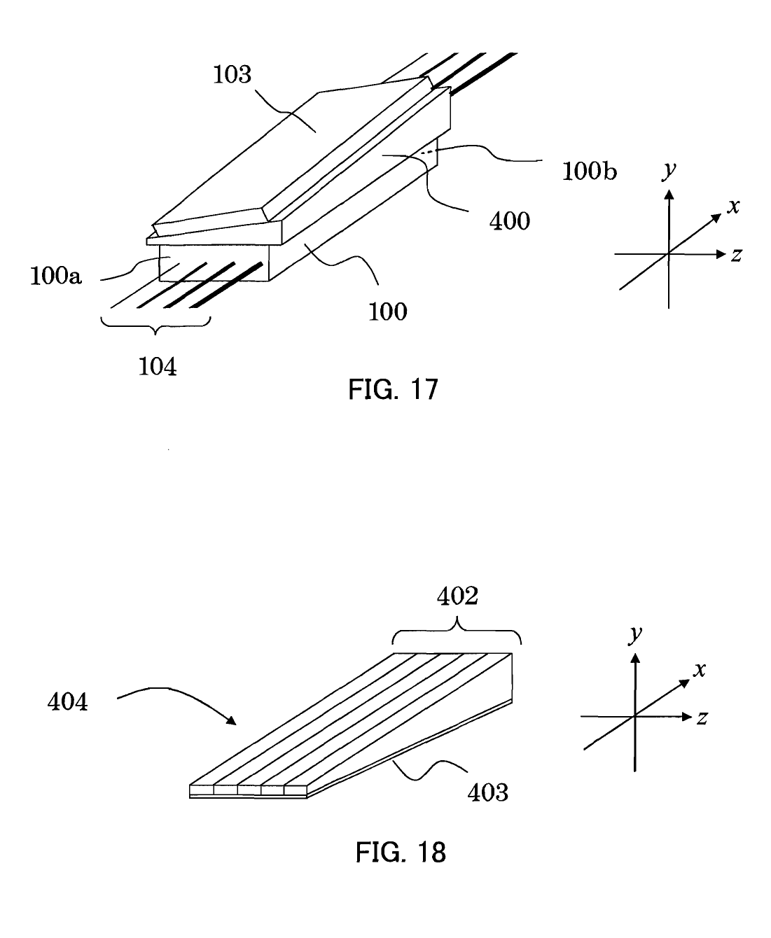

FIG. 15 and FIG. 16 are transparent views of the temperature control apparatus according to Embodiment 4 of the present invention. FIG. 17 is a perspective view of the temperature control apparatus according to Embodiment 4 of the present invention. FIG. 18 to FIG. 21 are perspective views of the heat conducting elements used in the temperature control apparatus according to Embodiment 4 of the present invention.

FIG. 15 is a transparent view of the temperature control apparatus with wedge-shaped heat conducting element 400 (form E) made entirely of the same substance and optical crystal 100 with the wavelength conversion function. Here, heat conducting element 400 (form E) becomes thicker from the front toward the back and from the left toward the right. For this reason, the thermal resistance of heat conducting element 400 (form E) becomes greater from the front toward the back and from the left toward the right.

FIG. 16 is a transparent view of the temperature control apparatus in FIG. 15 with cover 401 (form A) made of a heat conductive substance.

FIG. 17 shows a configuration of the temperature control apparatus in FIG. 15 with temperature control element 103. Then, the temperature control apparatus in FIG. 17 employs a configuration that allows a plurality of laser lights 104 to transmit in optical crystal 100. Here, a plurality of laser lights 104 are incident on different locations in optical crystal 100, all parallel to each other, in the same direction. Further, the intensities of the incident laser lights become weaker from the right toward the left or from the left toward the right. This assumes temperature adjustment for the wavelength converting scheme of making a plurality of laser lights of different incident intensities incident on the optical crystal.

First, a case will be described where the temperature of optical crystal 100 is kept higher than the external temperature. In this case, laser light 104 is allowed to transmit from optical crystal end surface 100a toward optical crystal end surface 100b, and the incident intensity increases in proportion to the increase in the coordinate value in the z-axis direction (hereinafter “z-axis coordinate value”). Then, the heating means such as a heater or Peltier element is used for temperature control element 103.

As described above, although incident laser light 104 produces uneven temperature distribution in the x-axis direction, the temperature control apparatus of the present embodiment is able to cancel unevenness in this temperature distribution according to the trend of the thermal resistance of heat conducting element 400 (form E) in the x-axis direction. This mechanism is the same as the mechanism described in Embodiment 1. Further, laser light 104 produces uneven temperature distribution in the z-axis direction because a laser light intensity increases in proportion to the increase in the coordinate value in the z-axis direction, and it naturally follows that the calorific value resulting from light absorption of optical crystal 100 increases in proportion to the increase in the coordinate value in the z-axis direction. Therefore, in optical crystal 100, a temperature distribution is produced where the temperature changes from low to high in the direction in which the z-axis coordinate value increases.

Then, the thickness and the thermal resistance of the heat conducting element (form E) are made thicker and greater in proportion to the increase in the z-axis coordinate value. By this means, more heat from the heating means is conducted in reverse proportion to the decrease in the z-axis coordinate value and less heat is conducted in reverse proportion to the increase in the z-axis coordinate value. As a result, it is possible to cancel unevenness in temperature distribution in the z-axis direction.

Next a case will be described where the temperature of optical crystal 100 is kept lower than the external temperature. In this case, laser light 104 is allowed to transmit from optical crystal end surface 100b toward optical crystal end surface 100a and its incident intensity is made less in reverse proportion to the increase in the z-axis coordinate value. Then, a cooling means such as a Peltier element is used for temperature control element 103. The mechanism in which unevenness in temperature distribution is cancelled in the x-axis direction is the same as the mechanism described in Embodiment 1.

As to the unevenness in temperature distribution in the z-axis direction, in this case, temperature distribution is produced where the temperature changes from high to low in proportion to the increase in the z-axis coordinate value. Then, the thickness and the thermal resistance of heat conducting element (form E) are made thicker and greater in proportion to the increase in the z-axis coordinate value. By this means, the cooling means absorbs more heat in reverse proportion to the decrease in the z-axis coordinate value and, on the other hand, absorbs less heat in reverse proportion to the increase in the coordinate value. As a result, it is possible to cancel unevenness in temperature distribution in optical crystal 100 in the z-axis direction.

Further, compared to the temperature control apparatus in FIG. 17, the temperature control apparatus with cover 401 (from A) in FIG. 16 requires the trouble of preparing a cover, but more successfully makes the temperature throughout optical crystal 100 uniform.

Further, instead of wedge-shaped heat conducting element 400 (form E), the heat conducting elements shown in FIG. 18 to FIG. 21 can be used.

Heat conducting element 404 (form F) in FIG. 18 is formed with at least two constituent elements 402 aligned in the z-axis direction on base 403 where the thermal resistance is uniform. Here, constituent elements 402 consist of substances of different thermal resistances. Further, constituent element 402 has over the x-axis direction the trend of thickness in the y-axis direction.

The unevenness in temperature distribution in the optical crystal in the x-axis direction is reduced by changing over the x-axis direction the thickness of the heat conducting element 404 (form F) in the y-axis direction change and then changing over the x-axis direction the thermal resistance of heat conducting element 404 (form F). Then, unevenness in temperature distribution in the optical crystal in the z-axis direction is reduced by aligning constituent elements 402 having different thermal resistances due to differences between substances.

Therefore, the thermal resistance of this heat conducting element 404 (form F) changes gradually in the x-axis direction and changes stepwise in the z-axis direction. A specific configuration is made such that thermal resistance of heat conducting element 404 (form F) increases by making heat conducting element 404 (form F) thicker in proportion the increase in the x-axis coordinate value. Further, the substances of constituent elements 402 are selected such that the thermal resistance of heat conducting element 404 (form F) becomes less in proportion to the increase in the z-axis coordinate value.

Then, by making the constituent element 402 side the joining face with optical crystal 100 and the base 403 side of the temperature control element (form F) the joining face with temperature control element 103, heat conducting element 404 (form F) can be replaced with heat conducting element 400 (form E) in FIG. 17. In this case, heat conducting element 404 (form F) shown in FIG. 18 is rotated 180 degrees around the x-axis and is replaced with heat conducting element 400 (form E) in FIG. 17.

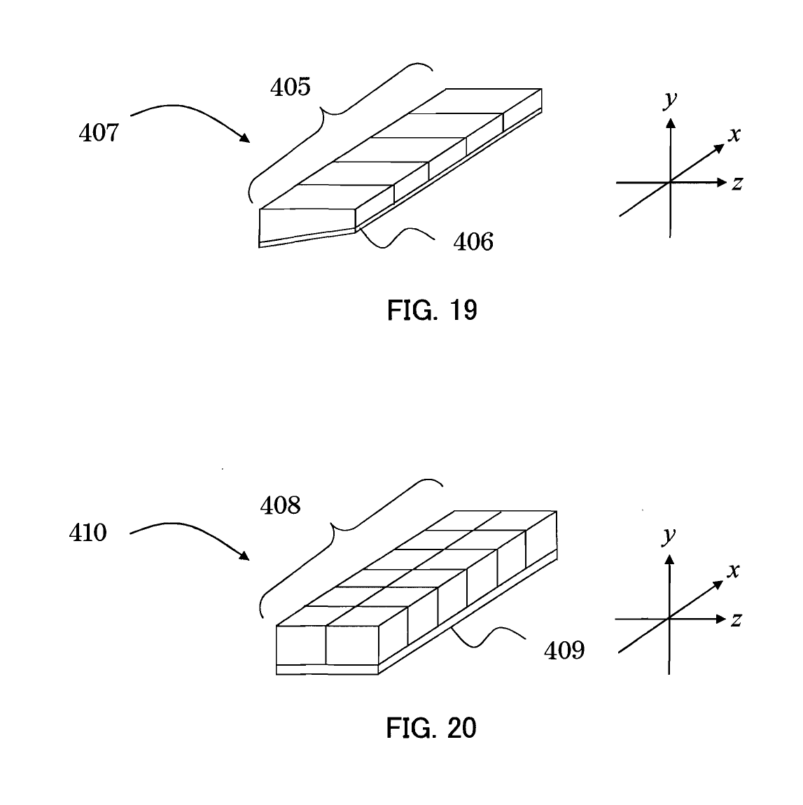

Heat conducting element 407 (form G) in FIG. 19 is formed with at least two constituent elements 405 aligned in the x-axis direction on base 406 where the thermal resistance is uniform. Here, constituent elements 405 consist of substances of different thermal resistances. Further, constituent element 405 has over the z-axis direction the thickness in the y-axis direction.

The unevenness in temperature distribution in the optical crystal in the x-axis direction is reduced by aligning constituent elements 405 having different thermal resistances due to differences between substances. The unevenness in temperature distribution in the optical crystal in the z-axis direction is reduced by making over the z-axis direction the thickness of heat conducting element 407 (form G) in the y-axis direction and then changing over the z-axis direction the thermal resistance of heat conducting element 407 (form G).

Therefore, the thermal resistance of this heat conducting element 407 (form G) changes continuously in the x-axis direction and changes stepwise in the z-axis direction. A specific configuration is made such that the thermal resistance of heat conducting element 407 (form G) increases by increasing the thickness in reverse proportion to the decrease in the z-axis coordinate value. Further, the substances of constituent element 405 are selected such that the thermal resistance of heat conducting element 407 (form G) becomes greater in proportion to the increase in the x-axis coordinate value.

Then, by making the constituent element 405 side the joining face with optical crystal 100 and the base 406 side of the temperature control element (form G) the joining face with the temperature control element, the heat conducting element (form G) can be replaced with heat conducting element 407 (form G) in FIG. 17. In this case, heat conducting element 407 (form G) shown in FIG. 19 is rotated 180 degrees around the x-axis and is replaced with heat conducting element 400 (form E) in FIG. 17.

Heat conducting element 410 (form H) in FIG. 20 is formed by aligning at least two constituent elements 408 in the z-axis direction and at least two constituent elements 408 in the x-axis direction on base 409 where the thermal resistance is uniform. Here, constituent elements 408 consist of substances which have different thermal resistances in the z-axis direction and they-axis direction.

Similar to heat conducting element 108 (form C) in FIG. 7, the differences between the thermal resistances in constituent elements 408 are realized by forming constituent element 408 using substances of different thermal resistances. Further, similar to heat conducting element 111 (form D), heat conducting element 410 (form H) can be formed by overlaying a plurality of substances of different or the same thermal resistances for each constituent element 408 in the y-axis direction. The above-described two techniques can be combined. A specific configuration is made by arranging constituent elements 408 on base 409 such that the thermal resistance increases stepwise in proportion to the increase in the coordinate value in the positive x-axis direction and in the negative z-axis direction.

Then, by making the constituent element 408 side the joining face with the optical crystal and the base 409 side of heat conducting element 410 (form H) the joining face with the temperature control element, heat conducting element 410 (form H) can be replaced with heat conducting element 400 (form E) in FIG. 17. In this case, heat conducting element 410 (form H) shown in FIG. 20 is rotated 180 degrees around the x-axis and is replaced with heat conducting element 400 (form E) in FIG. 17.

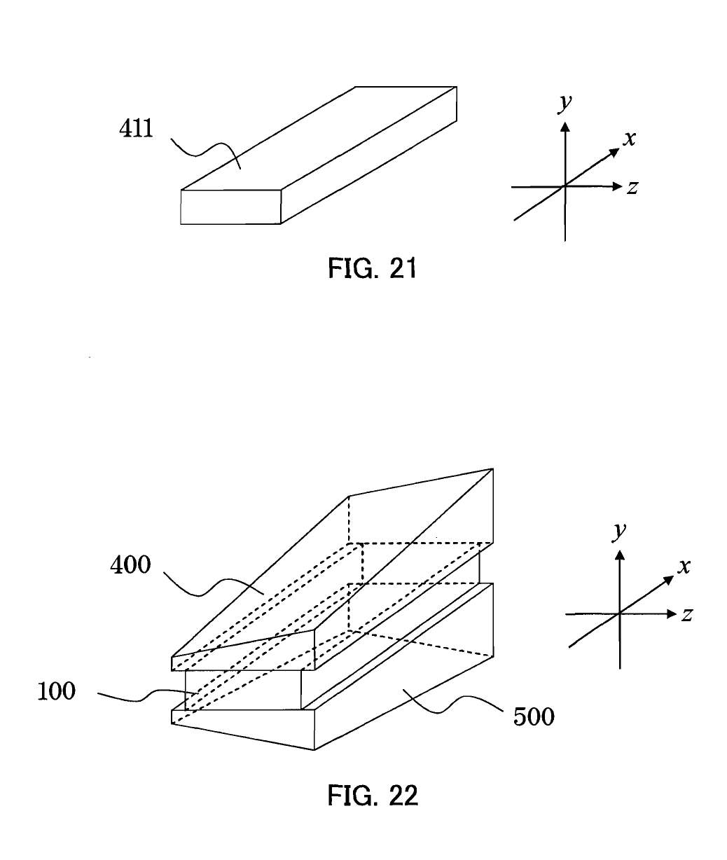

Heat conducting element 411 (form I) in FIG. 21 is configured with two substances of different thermal resistances (each substance consists of at least one element). By configuring heat conducting elements 411 (form I) such that the concentrations of these substances vary depending on locations in heat conducting element 411 (form I), a distribution of thermal resistance is formed where thermal resistance varies following the change in the x-axis direction and the change in the z-axis direction. By this means, unevenness in temperature distribution in optical crystal 100 which is produced when laser light 104 transmits in optical crystal 100, is cancelled. The mechanism is the same as the mechanism described with heat conducting element 105 (form B). A specific configuration is made such that the thermal resistance of heat conducting element 411 (form I) in the y-axis direction increases in proportion to the increase in the coordinate value in the positive x-axis direction and in the negative z-axis direction.

Then, by making the side where the coordinate value in the y-axis direction is larger the joining face with the optical crystal and the side where the coordinate value in the y-axis direction is smaller the joining face with the temperature control element, heat conducting element 411 (form I) can be replaced with heat conducting element 400 (form E) in FIG. 17. In this case, heat conducting element 411 (form I) shown in FIG. 21 is rotated 180 degrees around the x-axis and is replaced with heat conducting element (form E) in FIG. 17.

Further, heat conducting element 411 (form I) may consist of two or more substances.

Further, the heat conducting elements described so far can be used in combinations. Further, by making adjustments such that the thermal resistance in they-axis direction varies depending on locations in the heat conducting element, and nevertheless the thermal time constant is the same in all locations, there is a possibility to improve transient temperature distribution.

In all of these cases, the temperature sensor may be arranged to measure the temperatures at one given point of optical crystal 100. For example, a hole may be opened in the heat conducting element and a temperature sensor may be embedded in this hole. Then, the temperature control element controls the generation or absorption of heat to keep the temperature of the given point at a desired temperature, so that the temperature in other parts of optical crystal 100 is controlled to be kept at a desired temperature by means of the shape of the heat conducting element.

Further, although the joining faces of the heat conducting element with the optical crystal and with the temperature control element may be switched, the trend of the thermal resistance needs to be maintained.

In addition, given that the joining face of the heat conducting element with the temperature control element is flat and the joining faces of general heating and/or cooling means are usually linear or flat, the general heating and/or cooling means can easily be appropriated as the temperature control elements.

### Embodiment 5

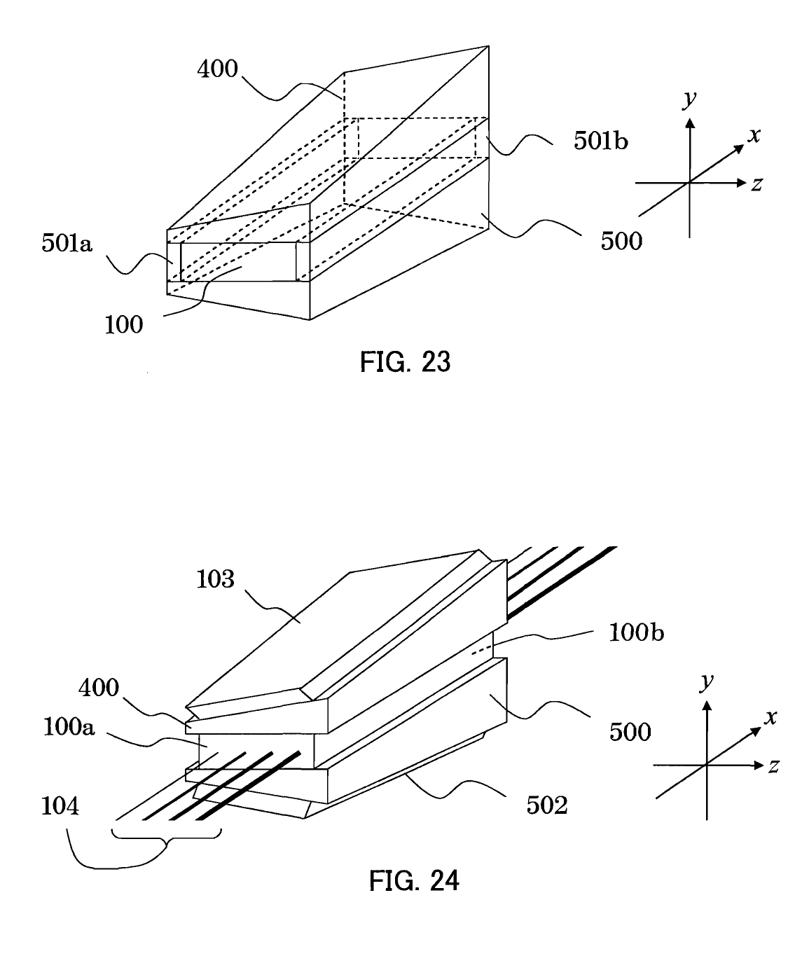

FIG. 22 and FIG. 23 are transparent views of temperature control apparatuses according to Embodiment 5 of the present invention. FIG. 24 is a perspective view of the temperature control apparatus according to Embodiment 5 of the present invention.

FIG. 22 is a transparent view of the temperature control apparatus with wedge-shaped heat conducting element 400 (form E) made entirely of the same substance, heat conducting element 500 (form E′) and optical crystal 100 with the wavelength conversion function. Here, heat conducting element 400 (form E) and heat conducting element 500 (form E′) become thicker from the front toward the back and from the left toward the right. For this reason, the thermal resistances of heat conducting element 400 (form E) and heat conducting element 500 (form E′) become greater from the front toward the back and from the left toward the right.

Further, the shape of heat conducting element 500 (form E′) is vertically symmetrical with respect to heat conducting element 400 (form E) sandwiching optical crystal 100. That is, the shape of heat conducting element 500 (form E′) is the shape that reverses heat conducting element 400 (form E) in the y-axis direction.

FIG. 23 is a transparent view of the temperature control apparatus with covers 501a and 501b (form B) made of a heat conductive substance.

FIG. 24 shows a configuration of the temperature control apparatus in FIG. 22 with temperature control elements 103 and 502. The temperature control apparatus in FIG. 24 employs a configuration that allows a plurality of laser lights 104 to transmit in optical crystal 100. Here, a plurality of laser lights 104 are incident on different locations of optical crystal 100, all parallel to each other, in the same direction. Further, the intensities of the incident laser lights become weaker from the right toward the left or from the left toward the right. This assumes temperature adjustment for the wavelength converting scheme of making a plurality of laser lights of different incident intensities incident on the optical crystal.

To keep the temperature of optical crystal 100 higher than the external temperature, laser light 104 is allowed to transmit from optical crystal end surface 100a toward optical crystal end surface 100b and its incident intensity is made greater in proportion to the increase in the z-axis coordinate value. Then, heating means such as heaters and Peltier elements are used for temperature control elements 103 and 502.

On the other hand, to keep the temperature of optical crystal 100 lower than the external temperature, laser light 104 is allowed to transmit from optical crystal end surface 100b toward optical crystal end surface 100a and its incident intensity is made weaker in reverse proportion to the increase in the z-axis coordinate value. Then, cooling means such as Peltier elements are used for temperature control elements 103 and 502.

The principle of operation of the temperature control apparatus according to the present embodiment is the same as the principle of operation of the temperature control apparatus according to Embodiment 4. In the temperature control apparatus of Embodiment 4 shown in FIG. 17, the temperature control element joins only with one side of optical crystal 100 through heat conducting element 400 (form E). For this reason, in the temperature control apparatus in FIG. 17, uneven temperature distribution is produced in optical crystal 100 in the y-axis direction. To alleviate this unevenness, there is a form where the temperature control apparatus is provided with cover 401 (form A) as in the temperature control apparatus described in Embodiment 4.

The temperature control apparatus according to the present embodiment increases the cost but nevertheless is able to further alleviate unevenness in temperature distribution in optical crystal 100 in the y-axis direction.

The temperature control apparatus according to the present embodiment employs a configuration where, instead of cover 401 (form A) in FIG. 16, another pair of a heat conducting element and a temperature control element are provided vertically symmetrical with respect to optical crystal 100. Here, two temperature control elements may use the same element instead of combinations of a heater and a Peltier element or combinations of Peltier elements of different characteristics. By so doing, the additional temperature control element to be added may be simply connected in serial or parallel with the existing temperature control elements connected with the temperature controlling circuit, so that an additional temperature controlling circuit needs not to be prepared.

Further, compared to the temperature control apparatus in FIG. 24, the temperature control apparatus with covers 501a and 501b (form B) in FIG. 23 requires the trouble of preparing covers, but more successfully make the temperature throughout optical crystal 100 uniform.

Furthermore, instead of wedge-shaped heat conducting element 400 (form E) and heat conducting element 500 (from E′), the heat conducting elements shown in FIG. 18 to FIG. 21 can be used. Note that, when the heat conducting elements shown in FIG. 18 to FIG. 21 are used instead of heat conducting element 500 (form E′), a heat conducting element is used that reverses over the y-axis direction the distribution of thermal resistance of heat conducting element 400 (form E) in the y-axis direction described in Embodiment 4, because heat conducting element 500 (form E′) employs a shape that reverses over the y-axis direction heat conducting element 400 (form E).

In all of these cases, the temperature sensor may be arranged to measure the temperature of one given point in optical crystal 100. For example, a hole may be opened in the heat conducting element and a temperature sensor may be embedded in this hole. Then, the temperature control element controls the generation or absorption of heat to keep the temperature of the given point at a desired temperature, so that the temperature in other parts of optical crystal 100 is controlled to be kept at a desired temperature by means of the shape of the heat conducting element.

Further, although the joining faces of the heat conducting element with the optical crystal and with the temperature control element may be switched, the trend of the thermal resistance needs to be maintained.

Furthermore, given that the joining face of the heat conducting element with the temperature control element is flat and the joining faces of general heating and/or cooling means are usually linear or flat, the general heating and/or cooling means can easily be appropriated as the temperature control elements.

### Embodiment 6

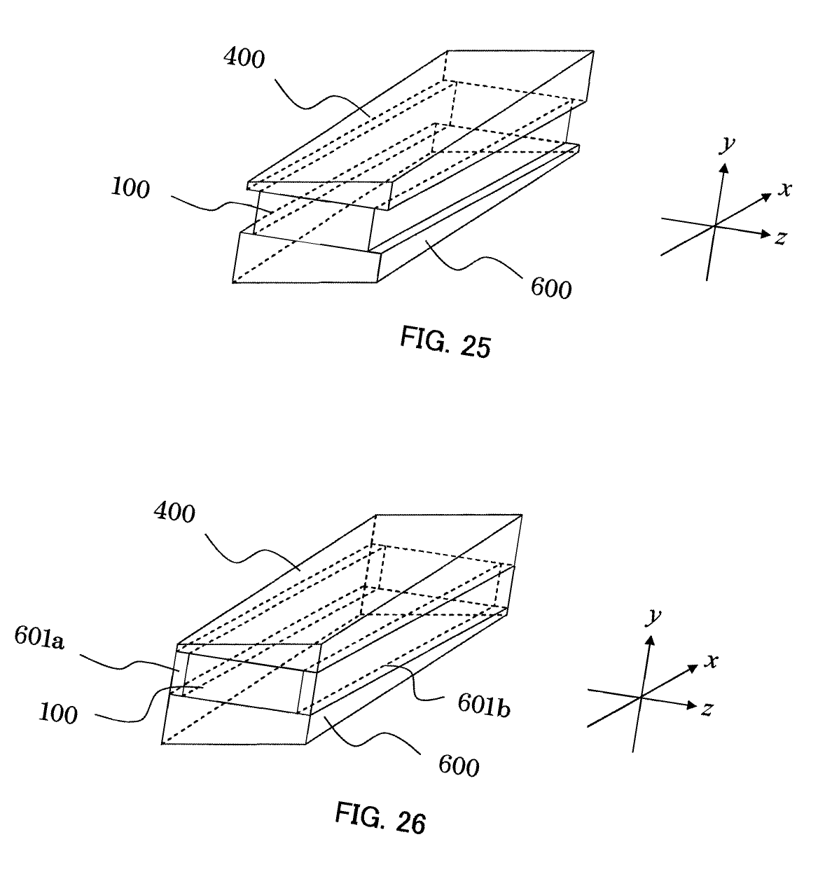

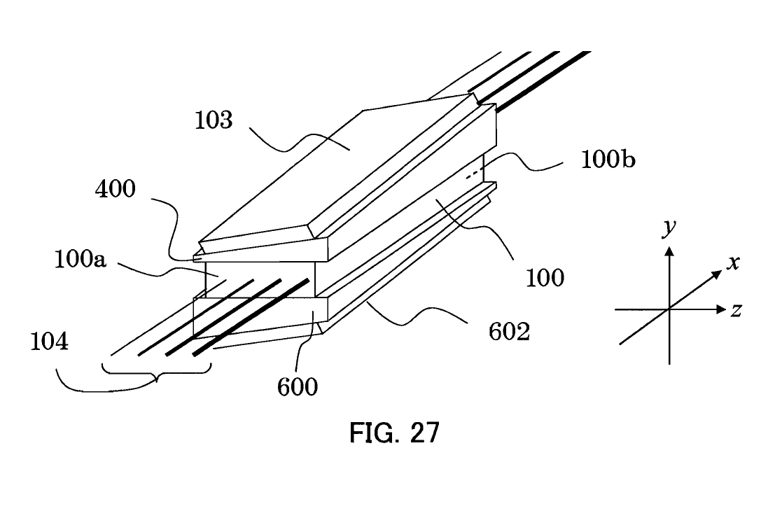

FIG. 25 and FIG. 26 are transparent views of the temperature control apparatus according to Embodiment 6 of the present invention. FIG. 27 is a perspective view of the temperature control apparatus according to Embodiment 6 of the present invention.

FIG. 25 is a transparent view of the temperature control apparatus with wedge-shaped heat conducting element 400 (form E) and heat conducting element 600 (form E″) made entirely of the same substance, and optical crystal 100 with the wavelength conversion function. Here, heat conducting element 400 (form E) becomes thicker from the front toward the back and from the left toward the right. For this reason, the thermal resistance of heat conducting element 400 (form E) becomes greater from the front toward the back and from the left toward the right.

Further, heat conducting element 600 (form E″) employs a shape that reverses heat conducting element 400 (form E) over the z-axis direction, and joins with optical crystal 100 as shown in FIG. 25. That is, heat conducting element 600 (form E″) employs a shape reversing heat conducting element 400 (form E) over the z-axis direction and then rotating this 180 degrees around the z-axis. Further, heat conducting element 600 (form E″) has practically the same shape as heat conducting element 500 (form E′), but is assigned a different reference numeral for ease of understanding.

FIG. 26 is a transparent view of the temperature control apparatus in FIG. 25 with covers 601a and 601b (form B) made of a heat conductive substance.

FIG. 27 shows a configuration of the temperature control apparatus in FIG. 25 with temperature control elements 103 and 602. Then, the temperature control apparatus in FIG. 27 employs a configuration that allows a plurality of laser lights 104 to transmit in optical crystal 100. Here, a plurality of laser lights 104 are incident on different locations in optical crystal 100, all parallel to each other, in the same direction. Further, the intensities of incident laser lights become weaker from the right toward the left or from the left toward the right. This assumes temperature adjustment for the wavelength converting scheme of making a plurality of laser lights of different incident intensities incident on the optical crystal.

With Embodiment 4 and Embodiment 5, only one of a heating means and a cooling means is used for the temperature control element. With the present embodiment, the temperature of optical crystal 100 is controlled using both a heating means and a cooling means for the temperature control elements. Further, according to this configuration, both in the case where the temperature of optical crystal 100 is kept higher than the external temperature and in the case where the temperature of optical crystal 100 is kept lower than the external temperature, the direction of incident laser light 104 (from which of optical crystal end surfaces 100a or 100b laser light 104 is incident) and the order of light intensity in the z-axis direction are fixed and do not change.

Referring to FIG. 27, a case will be described where laser lights 104 are allowed to transmit from optical crystal end surface 100a toward optical crystal end surface 100b and the intensity of each incident laser light is greater in proportion to the increase in the z-axis coordinate value. At this time, the heating means is used for temperature control element 103 and the cooling means is used for temperature control element 602.

It is important that, from optical crystal end surface 100a toward optical crystal end surface 100b, and in proportion to the increase in the z-axis coordinate value, the thermal resistance of heat conducting element 400 (form E) joins with the heating means becomes greater. Further, it is also important that, from optical crystal end surface 100a toward optical crystal end surface 100b, and in reverse proportion to the increase in the z-axis coordinate value, the thermal resistance of heat conducting element 600 (form E″) joins with the cooling means becomes less. Furthermore, it is important that, from optical crystal end surface 100a toward optical crystal end surface 100b, and in proportion to the increase in the z-axis coordinate value, the calorific value resulting from light absorption by the optical crystal increases. By applying the above three points to the configuration of the temperature control apparatus, according to the above mechanism, the unevenness in temperature distribution in optical crystal 100 is canceled and made uniform.

What to select for the heating means and the cooling means and the method of connecting these means with the temperature controlling circuit are described in Embodiment 3.

Further, compared to the temperature control apparatus in FIG. 27, the temperature control apparatus with covers 601a and 601b (form B) in FIG. 26 requires the trouble of preparing covers, but more successfully makes the temperature throughout optical crystal 100 uniform.

Furthermore, instead of wedge-shaped heat conducting element 400 (form E) and heat conducting element 600 (form E″), the heat conducting elements shown in FIG. 18 to FIG. 21 can be used. Note that, when the heat conducting elements shown in FIG. 18 to FIG. 21 are used instead of heat conducting element 600 (form E″), a heat conducting element is used that reverses over the z-axis direction the distribution of thermal resistance of heat conducting element 400 (form E) in the y-axis direction described in Embodiment 4, because heat conducting element 600 (form E″) employs a shape that reverses heat conducting element 400 (form E) in the y-axis direction.

In all of these cases, the temperature sensor may be arranged to measure the temperature of one given point in optical crystal 100. For example, a hole may be opened in the heat conducting element and a temperature sensor may be embedded in this hole. Then, the temperature control element controls the generation or absorption of heat to keep the temperature of the given point at a desired temperature, so that the temperature in other parts of optical crystal 100 is controlled to be kept at a desired temperature by means of the shape of the heat conducting element.

Further, although the joining faces of the heat conducting element with the optical crystal and with the temperature control element may be switched, the trend of the thermal resistance needs to be maintained.

Furthermore, given that the joining face of the heat conducting element with the temperature control element is flat and the joining faces of general heating and/or cooling means are usually linear or flat, the general heating and/or cooling means can easily be appropriated as the temperature control elements.

### Embodiment 7

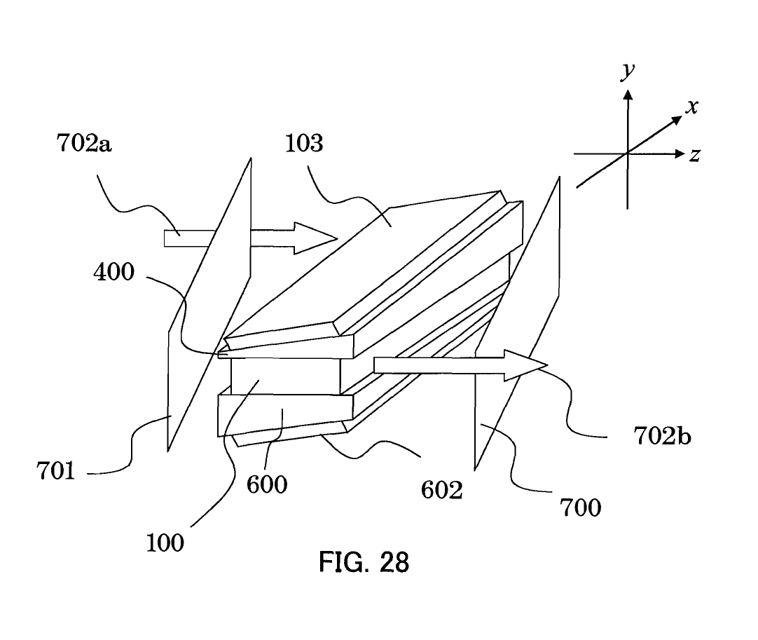

FIG. 28 is a perspective view of the temperature control apparatus according to Embodiment 7 of the present invention.

This temperature control apparatus in FIG. 28 employs a configuration that adds separator 700 that passes only converted lights and reflects non-converted lights in incident lights 702a, and mirror 701 that reflects both converted lights and non-converted lights, to the temperature control apparatus in FIG. 27 where the input and output positions and the number of laser lights 104 are changed. Further, separator 700 and mirror 701 are arranged in parallel to each other. This temperature control apparatus is effective to control the temperature of the optical crystal of a known reflective reciprocating wavelength conversion apparatus. Almost all of output lights 702b of the temperature control apparatus become converted lights.

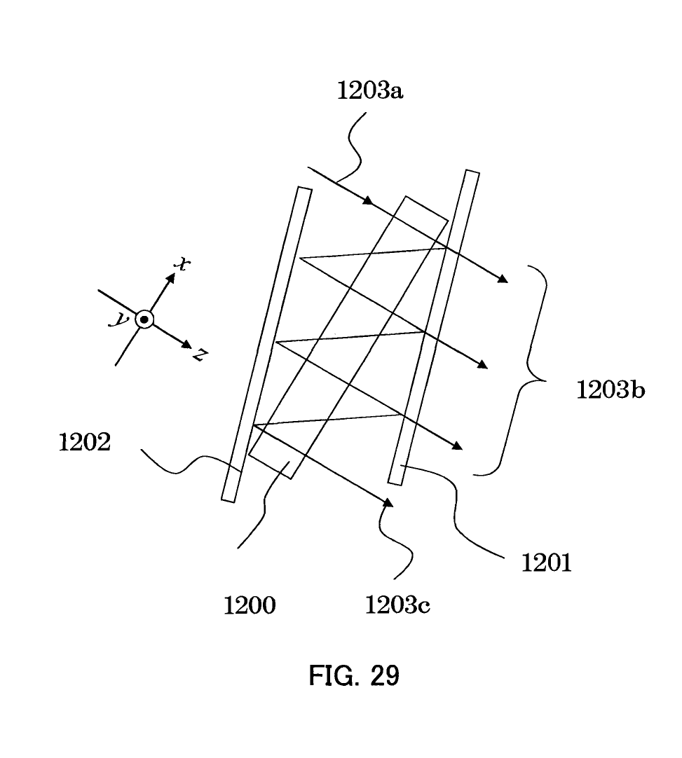

FIG. 29 is a schematic view of a known reflective reciprocating wavelength conversion apparatus (for example, see Japanese Patent Application Laid-Open No. HEI6-43514).

The reflective reciprocating wavelength conversion apparatus in FIG. 29 is formed with optical crystal 1200 with the wavelength conversion function, separator 1201 and mirror 1202. Here, incident light 1203a is reflected back and forth between two reflectors 1200 and 1201, and transmit in the optical crystal several times. At this time, part of the incident light is converted into a harmonic as converted light 1203b and is separated at separator 1201. In incident light 1203a, converted light 1203b is separated and the rest of incident light 1203a is outputted as output light 1203c.

This process produces temperature distribution in optical crystal 1200 where, in proportion to the increase in the z-axis coordinate value and in proportion to the increase in the x-axis coordinate value, the temperature changes from low to high. The quantity of harmonic components increases toward the positive z-axis direction, and the non-converted light of the source becomes weaker toward the negative x-axis direction.

Although similar uneven temperature distribution is produced in optical crystal 100 in FIG. 28, this unevenness can be cancelled by the uneven thermal resistance distribution of the heat conducting element in the y-axis direction. The mechanism whereby unevenness in temperature distribution is canceled is the same as the mechanism described in Embodiment 6.

Further, a wavelength converting apparatus that replaces separator 1201 in FIG. 29 with a mirror is known. In this case, converted lights are not separated in the separator. Therefore, in proportion to the increase in the z-axis coordinate value and in reverse proportion to the decrease in the x-axis coordinate value, temperature distribution is produced where the temperature changes from low to high, because the quantity of harmonic components increase toward the positive z-axis direction, and converted lights are not separated and so the quantity of harmonic components increases toward the negative x-axis direction. To reduce unevenness in such temperature distribution in the temperature control apparatus shown in FIG. 28 that replaces separator 700 with a mirror, shapes of heat conducting element 400 (form E) and heat conducting element 600 (form E″) may be changed to be reversed over the x-axis direction.

Further, instead of wedge-shaped heat conducting element 400 (form E) and heat conducting element 600 (form E″), the heat conducting elements shown in FIG. 18 to FIG. 21 can be used. However, a notice described in Embodiment 6 should be given a special attention.

In addition, the temperature control apparatus shown in FIG. 28 can be replaced with the temperature control apparatuses described in Embodiment 4 to Embodiment 6. Further, if the unevenness in temperature distribution in the z-axis direction can be disregarded, the temperature control apparatus shown in FIG. 28 can be replaced with the temperature control apparatuses described in Embodiment 1 to Embodiment 3.

In all of these cases, the temperature sensor may be arranged to measure the temperature of one given point in optical crystal 100. For example, a hole may be opened in the heat conducting element and a temperature sensor may be embedded in this hole. Then, the temperature control element controls the generation or absorption of heat to keep the temperature of the given point at a desired temperature, so that the temperature in other parts of optical crystal 100 is controlled to be kept at a desired temperature by means of the shape of the heat conducting element.

Further, although the joining faces of the heat conducting element with the optical crystal and with the temperature control element may be switched, the trend of the thermal resistance needs to be maintained.

Furthermore, given that the joining face of the heat conducting element with the temperature control element is flat and the joining faces of general heating and/or cooling means are usually linear or flat, the general heating and/or cooling means can easily be appropriated as the temperature control elements.

### Embodiment 8

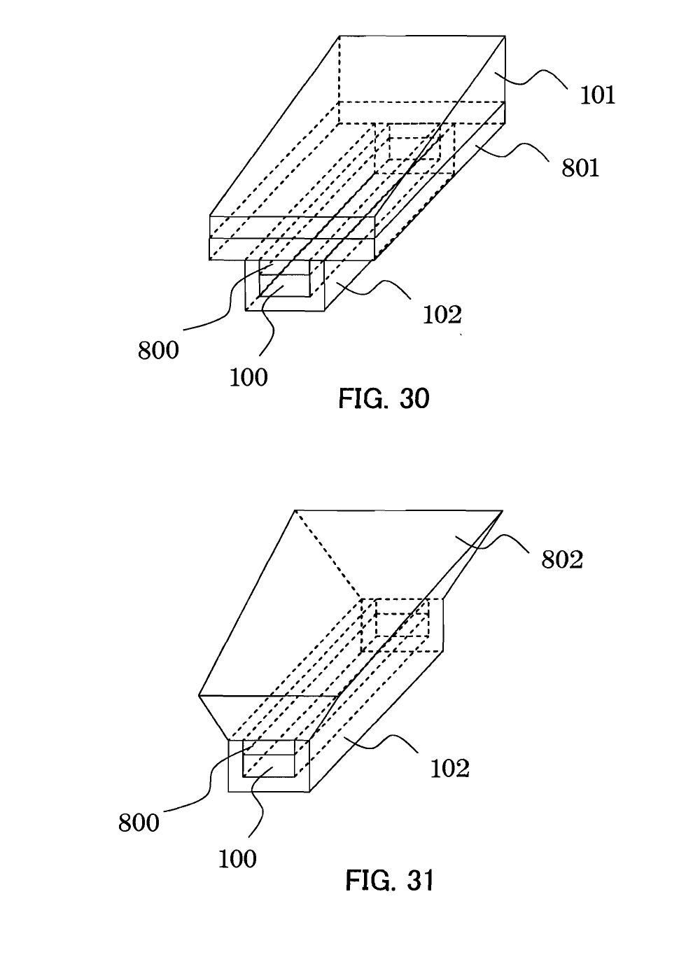

FIG. 30 is a transparent view of the temperature control apparatus according to Embodiment 8 of the present invention. FIG. 31 is a transparent view of the temperature control apparatus according to Embodiment 8 of the present invention.

The temperature control apparatus in FIG. 30 has optical crystal 100, cover 102 (form A) that is made of a heat conductive substance and that covers optical crystal 100 and connecting members 800 and 801 that are made of heat conductive substances and that connect optical crystal 100 with heat conducting element 101 (form A).

The temperature control apparatus in FIG. 31 has optical crystal 100, cover 102 (form A) that is made of a heat conductive substance and that covers optical crystal 100 and connecting member 800 that is made of a heat conductive substance and that connects optical crystal 100 with heat conducting element 802 (form J).

When the size of the temperature control element and the size of the optical crystal used to convert the wavelength are close, the temperature can be controlled according to the examples described with the above embodiments using the drawings. However, when a small optical crystal is used, device for connecting the temperature control element, heat conducting element and optical crystal is necessary.

The temperature control apparatus in FIG. 30 adopt a form that simply increases the size of heat conducting element 101 (form A) in FIG. 4 and adds connecting members 800 and 801. The size in the longitudinal direction is the same as optical crystal 100 in FIG. 30 but may be made longer than the longitudinal length of optical crystal 100.

Further, heat conducting element 101 (form A) can join directly with optical crystal 100 without connecting members 800 and 801. As described above, for the heat conducting element, only the size of the joining face may be operated, and this kind of modification can be applied to all heat conducting elements described so far.

The temperature control apparatus in FIG. 31 is in a form that is able to adopt the temperature control apparatus shown in FIG. 4 when the optical crystal is smaller than the temperature control element. To be more specific, the face of heat conducting element 101 (form A) of the optical crystal 100 side is made small to match the size of optical crystal 100. Then, the joining face with the temperature control element is modified bigger to a size that can join with the temperature control element.

Further, heat conducting element 802 (form J) can join directly with optical crystal 100 without connecting member 800.

The temperature control apparatus in FIG. 31 differs from the temperature control apparatus in FIG. 30 in increasing only the size of the joining face of heat conducting element 802 (form J) on the temperature control element side instead of increasing both the size of the joining face of heat conducting element 802 (form J) on the temperature control element side and the size of the joining face on the optical crystal side. The temperature control apparatus in FIG. 31 is more difficult to manufacture, but is useful in reducing the thermal capacity of heat conducting element 802 (form J) compared to thermal capacity of the heat conducting element processed according to the method shown in FIG. 30 (that is, the volume can be reduced). Further, the present embodiment is applicable to all the heat conducting elements described so far.

### Embodiment 9

Although cases have been described with the above embodiments where a harmonic generation element is used for the optical crystal, this does not limit the present invention. The present invention is applicable to various types of wavelength converting elements that generate in the crystal a beam that has the different wavelength from the beam incident on the optical crystal. Wavelength converting elements other than the above harmonic generation element include, for example, a sum frequency generation element, difference frequency generation element and parametric amplification element.

Wavelength conversion in the crystal produces in the traveling direction of the beam an uneven distribution in the intensity of the wavelength which is included in the beam at each location of the optical path in the crystal. That is, light absorption of the optical crystal that has dependence on wavelength produces uneven temperature distribution. If the wavelengths of the beams generated by conversion are shorter than wavelengths of (a single or plurality of) incident beams, generally, temperature distribution is produced where the temperature changes from low to high from the input end of the crystal toward the output end. On the other hand, if the wavelengths of beams generated by conversion are longer than wavelengths of (a single or plurality of) incident beams, temperature distribution is produced where the temperature changes from high to low from the input end of the crystal toward the output end. Taking into account the wavelengths and intensities, distribution of the thermal resistance of the heat conducting element or both distributions of thermal resistance and thermal capacity may be decided.

Further, the form of the heat conducting element is not limited to the examples described in the above embodiments. It is possible to employ various types of forms that conduct different amounts of heat depending on locations in the heat conducting element to reduce the temperature variations inside the optical crystal by, for example, changing the area of the joining face of the heat conducting element with the optical crystal along the traveling direction of the beam or changing the density of the substance of the heat conducting element as described above along the traveling direction of a beam. To support a non-linear phenomenon where, for example, conversion is intense in particular in the center part of the crystal, the cross sections of the heat conducting element are made the same at the ends of the input and output, and heat conduction may be changed only between the ends of the input and output.

The temperature control apparatus for optical crystal according to the present invention is able to improve the efficiency of the wavelength converting element that is able to produce laser light in wavelengths that are difficult to oscillate with lasers, so that it is possible to obtain, for example, quality green laser light. Such quality green laser light is suitable as medical laser light and is anticipated to make a significant contribution to the medical field. Further, the combination of quality green laser light with red laser light and blue laser light can provide the light source that is able to represent any color. Such light source that is able to represent any color is suitable for display apparatuses including, for example, the light source for imaging apparatus or the backlight apparatus for liquid crystal display apparatus.

What is claimed is:

1. A temperature control apparatus for optical crystal, comprising:
an optical crystal that allows a beam to transmit inside the optical crystal;
a temperature control element that generates or absorbs heat; and
a heat conducting element that is arranged between the temperature control element and the optical crystal and conducts heat between the temperature control element and the optical crystal,
wherein the heat conducting element conducts different amounts of heat depending on locations in the heat conducting element to reduce a temperature variation in the optical crystal.

2. The temperature control apparatus for optical crystal according to claim 1, wherein the heat conducting element conducts different amounts of heat between locations in the heat conducting element meeting an input end and an output end of the beam in the optical crystal.

3. The temperature control apparatus for optical crystal according to claim 1, wherein, in the heat conducting element, at least one of thermal resistance and thermal capacity varies depending on locations in the heat conducting element.

4. The temperature control apparatus for optical crystal according to claim 1, wherein, in the heat conducting element, at least one of a cross section and a substance varies depending on locations in the heat conducting element.

5. The temperature control apparatus for optical crystal according to claim 1, wherein a thickness of the heat conducting element varies depending on locations in the heat conducting element in relationship to the optical crystal.

6. The temperature control apparatus for optical crystal according to claim 1, wherein a concentration of a substance contained in the heat conducting element varies depending on locations in the heat conducting element in relationship to the optical crystal.

7. The temperature control apparatus for optical crystal according to claim 1, wherein the heat conducting element is comprised of a plurality of elements in which at least one of thermal resistance and thermal capacity varies due to a difference between substances.

8. The temperature control apparatus for optical crystal according to claim 1, further comprising a temperature sensor that measures a temperature of the optical crystal,
wherein the temperature control element controls an amount of heat generated or an amount of heat absorbed according to a measurement result in the temperature sensor.

9. The temperature control apparatus for optical crystal according to claim 2, wherein:
when an amount of heat generated at the input end inside the optical crystal is less than an amount of heat generated at the output end,
the temperature control element generates heat; and
the heat conducting element conducts more heat in a location in the heat conducting element meeting the input end of the beam in the optical crystal than in a location in the heat conducting element meeting the output end of the beam in the optical crystal.

10. The temperature control apparatus for optical crystal according to claim 2, wherein:
when an amount of heat generated at the input end inside the optical crystal is smaller than an amount of heat generated at the output end,
the temperature control element absorbs heat; and
the heat conducting element conducts more heat in a location in the heat conducting element meeting the output end of the beam in the optical crystal than in a location in the heat conducting element meeting the input end of the beam in the optical crystal.

11. The temperature control apparatus for optical crystal according to claim 2, wherein:
when an amount of heat generated at the input end inside the optical crystal is greater than an amount of heat generated at the output end,
the temperature control element generates heat; and
the heat conducting element conducts more heat in a location in the heat conducting element meeting the output end of the beam in the optical crystal than in a location in the heat conducting element meeting the input end of the beam in the optical crystal.

12. The temperature control apparatus for optical crystal according to claim 2, wherein:
when an amount of heat generated at the input end inside the optical crystal is greater than an amount of heat generated at the output end,
the temperature control element absorbs heat; and
the heat conducting element conducts more heat in a location in the heat conducting element meeting the input end of the beam in the optical crystal than in a location in the heat conducting element meeting the output end of the beam in the optical crystal.

13. The temperature control apparatus for optical crystal according to claim 1, wherein:
the optical crystal allows a first beam and a second beam with a different incident intensity from the first beam, to transmit in the optical crystal; and
the heat conducting element conducts different amounts of heat between locations in the heat conducting element meeting a first beam end and a second beam end in the optical crystal to reduce a temperature variation inside the optical crystal.

14. The temperature control apparatus for optical crystal according to claim 1, further comprising two pairs of the temperature control element and the heat conducting element,
wherein the optical crystal is sandwiched between the two pairs.

15. The temperature control apparatus for optical crystal according to claim 1, wherein the optical crystal has a wavelength conversion function.

16. The temperature control apparatus for optical crystal according to claim 15, wherein the optical crystal comprises a harmonic generation element.

17. The temperature control apparatus for optical crystal according to claim 15, wherein the optical crystal comprises a sum frequency generation element.

18. The temperature control apparatus for optical crystal according to claim 15, wherein the optical crystal comprises a difference frequency generation element.

19. The temperature control apparatus for optical crystal according to claim 15, wherein the optical crystal comprises an optical parametric amplification element.
